(19) United States
(12) Patent Application Publication
(10) Pub. No.: US 2025/0356363 A1
(43) Pub. Date: Nov. 20, 2025

(54) MACHINE LEARNING BASED SYSTEMS AND METHODS FOR DETECTING AND CORRECTING MISCLASSIFIED DATA

(71) Applicant: MASTERCARD INTERNATIONAL INCORPORATED, Purchase, NY (US)

(72) Inventor: Wally F. Lo Faro, St. Louis, MO (US)

(21) Appl. No.: 18/665,303

(22) Filed: May 15, 2024

(51) Int. Cl. G06Q 20/40

(52) U.S. Cl. CPC G06Q 20/405; G06Q 20/401

(57) ABSTRACT

A computer system and method having a machine learning tool for identifying and correcting a misclassified merchant category code (MCC). The system includes a computer device that has at least one processor configured to store a first propensity model that is trained with multiple account identifiers that are used to initiate multiple purchase transactions with multiple merchants each having been properly assigned to a first MCC. The system inputs into the first propensity model an account identifier used to initiate a purchase transaction with a candidate merchant assigned to the first MCC. The candidate merchant possibly being mis-assigned to the wrong MCC. The system outputs from the first propensity model a first score based on the inputted account identifier, compares the outputted score to a threshold value, and based on the comparison, determines that the candidate merchant was mis-assigned to the first MCC.

### BACKGROUND

The field of the present disclosure relates generally to detecting and correcting misclassified data, and more particularly to machine learning based systems and methods for detecting and correcting a misclassified merchant category code (MCC) assigned to a merchant within transaction data being processed over a network.

A merchant category code (MCC) is in some cases assigned to merchants when processing payment transactions over a network. The MCC is included within the transaction data that is processed in order to classify merchants into categories based on the primary types of goods or services they sell. More specifically, the MCC assigned to each merchant should accurately reflect the predominant business of the merchant. The MCC is used by multiple parties during a payment transaction including issuing banks (e.g., the cardholder's financial institution), acquiring banks (e.g., the merchant's financial institution), and the payment processing network.

The acquiring bank may use the MCC to determine interchange fees, the transaction fees paid by the acquiring bank, to cover the cost of risks involved in approving a payment transaction with the merchant. High-risk merchants are typically associated with high-risk industries, which pose a greater risk of chargebacks (e.g., the return of funds to a consumer initiated by an issuing bank), have an elevated fraud risk, and/or are heavily regulated in certain jurisdictions. For example, high-risk merchants may include online casinos, online pharmacies, adult content websites, and the sale of cryptocurrencies. High-risk merchants typically pay a higher interchange rate than lower risk merchants, and acquiring banks identify high-risk merchants based on their assigned MCC.

The MCCs may also be used by the issuing bank to determine a cash-back reward. The issuing bank may provide incentives or rewards to the cardholders for purchase transactions made with certain types of merchants. For example, the issuing bank may pay a cash-back reward to cardholders for purchase transactions made at grocery stores and supermarkets. The issuing bank utilizes the MCC assigned to the merchant to confirm that the cardholder initiated a purchase transaction with a grocery store. In addition, the MCC may be used to restrict payment transactions and to determine legal and tax reporting duties. For example, online gambling is only permitted in a few states within the United States and issuers may use the MCC to identify and prevent gambling transactions coming from states in which online gambling is restricted.

For at least these reasons, it is crucial that the MCC assigned to each merchant accurately reflects the predominant business of the merchant. Typically, acquiring banks are tasked with the duty of assigning a MCC to merchants. In some cases, the merchants provide descriptions or documentations of the types of goods and services the merchant provides. The payment processing network provides MCC assignment guidelines and MCC classification descriptions to the acquiring banks. Acquiring banks may evaluate the merchant documentation provided by the merchant along with the guidelines and descriptions provided by the payment processing network to assign a MCC to the merchant.

In some cases, the MCC assigned to the merchant may not accurately represent the primary business of the merchant. For example, the acquirer may mistakenly assign an incorrect MCC to a merchant (e.g., the acquiring bank may have misinterpreted the merchant documentation or incorrectly applied the guidelines). In other cases, a merchant may have intentionally provided misleading information about the primary business of the merchant, for example a high-risk merchant may provide fraudulent or misleading documentation in order to be assigned to a lower risk MCC for the purpose of eliciting a lower interchange rate.

Often it is too tedious and time consuming for the acquiring bank to manually investigate each and every merchant doing business with the acquiring bank to confirm that the merchant is correctly assigned to an MCC. Acquiring banks typically do not have the computing resources or personnel available for painstaking review of a merchant's actual business operations (e.g., via web searches of the merchant's business activities or electronic information requests via the merchant's consumer portal or email), and therefore, they usually just use the merchant information provided to the acquiring bank when assigning the MCC. Moreover, while payment networks have access to transaction data for merchants across a large number of acquiring banks, a correspondingly larger amount of computing resources and personnel trained in detection would be required to reliably investigate merchants one-by-one to locate MCC-misclassified merchants. It is desirable to have a system capable of automatically identifying merchants that are likely MCC-misclassified that operates with reduced or eliminated manual input, no requirement for additional dedicated data collection, no dependence on merchant-provided descriptions of the merchant's business, and reduced usage of computer resources.

### BRIEF DESCRIPTION

In one aspect, a computer-implemented method using a machine learning tool for identifying and correcting a misclassified merchant category code (MCC) included within an authorization request message is provided. The computer-implemented method implemented using a computer device including at least one processor. The method comprising: (i) storing a first propensity model that is trained with multiple account identifiers used to initiate multiple purchase transactions with multiple merchants each having been properly assigned to a first MCC; (ii) inputting, into the first propensity model, an account identifier used to initiate a purchase transaction with a candidate merchant assigned to the first MCC, the candidate merchant possibly being mis-assigned to a wrong MCC; (iii) outputting from the first propensity model a first score based on the inputted account identifier; (iv) comparing the outputted score to a threshold value; and (v) based on the comparison to the threshold value, determine that the candidate merchant was mis-assigned to the first MCC.

In another aspect, a computing device that includes at least one processor and a memory in communication with the at least one processor is provided. The memory for storing a first propensity model that is trained with multiple account identifiers used to initiate multiple purchase transactions with multiple merchants each having been properly assigned to a first merchant category codes (MCC), and instructions that when executed by the at least one processor, cause the at least one processor to: (i) input, into the first propensity model, an account identifier used to initiate a purchase transaction with a candidate merchant assigned to the first MCC, the candidate merchant possibly being mis-assigned to a wrong MCC; (ii) output from the first propensity model a first score based on the inputted account identifier; (iii) compare the outputted score to a threshold value; and (v) based on the comparison to the threshold value, determine that the candidate merchant was mis-assigned to the first MCC.

In another aspect, a non-transitory computer-readable storage medium that includes computer-executable instructions is provided. When executed by at least one processor, the computer-executable instructions cause the at least one processor to: (i) store a first propensity model that is trained with multiple account identifiers used to initiate multiple purchase transactions with multiple merchants each having been properly assigned to a first MCC; (ii) input, into the first propensity model, an account identifier used to initiate a purchase transaction with a candidate merchant assigned to the first MCC, the candidate merchant possibly being mis-assigned to a wrong MCC; (iii) output from the first propensity model a first score based on the inputted account identifier; (iv) compare the outputted score to a threshold value; and (v) based on the comparison to the threshold value, determine that the candidate merchant was mis-assigned to the first MCC.

### BRIEF DESCRIPTION OF THE DRAWINGS

FIG. 1 is a schematic diagram illustrating an example multi-party payment processing system for enabling payment-by-card or payment-by-account transactions with a merchant assigned to an MCC.

FIG. 2 is a block diagram of an example embodiment of a system that includes a model configured to receive inputs comprising indicators used to determine a merchant market hierarchy identifier (MMHID) that has potentially been assigned an incorrect MCC.

FIG. 3 is a block diagram of an example embodiment of a system that includes a propensity model used to determine whether an originally assigned MCC is correct for an identified MMHID of a merchant.

FIG. 4 is a block diagram of an example embodiment of a system that includes an MCC determination module configured to recommend an accurate MCC by evaluating outputs from a plurality of propensity models that model PAN data associated with misclassified merchant.

FIG. 5 shows an example configuration of an MCC-misclassification identification computing device, in accordance with examples of the present disclosure.

FIG. 6 is a flow diagram illustrating an example method of identifying an MCC-misclassified merchant and suggesting an alternative MCC.

### DETAILED DESCRIPTION

The systems and methods described herein are directed to identifying MCC-misclassified merchants. An MCC-misclassified merchant is a merchant which has been incorrectly assigned to a merchant category code (MCC). The MCC is a classification code assigned to a merchant based on the merchant's predominant business activity (e.g., the primary goods or services provided by the merchant). More specifically, the MCC classifies merchants into specific market segments or categories. The MCCs are assigned to accurately reflect the merchant's primary business to facilitate risk management, assign interchange fees, and/or enable other value-added services to be provided by participants in a payment processing network. The MCC may be a four-digit number or an alphanumeric code that is used to distinguish subtle differences between merchant types. For example, a MCC consisting of MCC5811 may be assigned to merchants that provide services associated with the preparation and delivery of food and drinks (e.g., a catering service) while a MCC consisting of MCC5812 may be assigned to merchants that prepare food and drink for immediate consumption (e.g., a restaurant). In some cases, more than one MCC may be assigned to a merchant. For example, a fuel filling station connected with a convenience store may be assigned to a first MCC representing fuel dispensing and a second MCC representing the face-to-face sale of other goods and services. The point-of-sale (POS) devices at such a merchant may be programmed to select either the first or second MCC for a given transaction based on the goods or services being purchased, or the MCC may be selected based upon a location of the POS device within the merchant premises.

MCCs are typically assigned by an acquirer (e.g., the merchant's financial institution or the merchant's bank). Acquirers aim to assign a valid and accurate MCC that most reasonably describes the primary business of the merchant. A payment processing network (e.g., a processing server or other computer device of the payment processing network) may provide guidelines and detailed descriptions of MCCs to assist acquires in assigning MCCs to merchants. More specifically, the payment processing network provides rules and responsibilities that acquirers have with merchants when assigning a MCC to a merchant. In addition, the guidelines explain how acquirers should assign one or more MCCs to a merchant such that the description associated with the MCC most accurately describes the business of the merchant.

Merchants may provide acquirers descriptions or documentation of the types of goods and services sold by the merchant. For example, a merchant may provide merchant data associated with the merchant, including merchant locations (e.g., the geographical location of a brick-and-mortar store or the location of ecommerce), financial statements, or images and or descriptions of the goods and services sold by the merchant. Utilizing the merchant data provided by the merchant and the guidelines provided by the payment processing network, the acquirer may assign a MCC to the merchant. In some cases, the assigned MCC does not accurately reflect the primary business of the merchant. For example, the merchant may provide the acquirer misleading information, either intentionally or unintentionally, about the primary business of the merchant. In some cases, the acquirer may misinterpret the documentation provided by the merchant or the acquirer may erroneously apply the guidelines for assigning an MCC. In other cases, the primary business of the merchant may have changed over time such that a previously assigned MCC no longer reflects the business of the merchant.

The MCC is used by multiple parties during a payment transaction. The issuer may use the MCC to determine if the issuer may accept a payment transaction from the merchant or to identify a prohibited business. For example, online gambling is only permitted in a few states within the United States. Issuers may use the MCC to identify a transaction with a merchant associated with gambling, and then to prevent gambling transactions from states that do not allow online gambling.

In addition, the MCC may be used to determine a payment card reward provided to cardholders for making purchases at certain types of merchants. For example, an issuer may provide a cash-back reward to incentivize customers to make purchases with grocery stores and supermarkets. The issuer may use the MCC to confirm that a transaction was performed at a grocery store and thus eligible for the targeted reward.

The MCC may also be used to assess the risk associated with the merchant to determine interchange fees (e.g., interchange plus pricing, true pricing, cost-plus pricing, etc.). The interchange fee is a fee typically paid by the acquirer to the issuer to compensate the issuer for values and benefits that the merchants receive when they accept electronic payments. In addition, the interchange fee is also associated with the risk associated with performing transactions with merchants. For example, low risk merchants, such as supermarkets, gas stations, and hotels, typically receive special reduced interchange fee pricing, which is an incentive for these merchants to accept credit cards. High-risk merchants may include start up organizations, merchants in industries that are heavily regulated, merchants in industries subject to an increased risk of fraudulent or frequent returns, or merchants in industries associated with a negative public perception of the industry as a whole. For example, high-risk merchants may include betting and casino gambling, wire transfer and money orders, cigar stores and or stands, and/or merchants offering drugs, proprietaries, and sundries.

The MCC assigned to a merchant is not always correctly assigned, that is, the MCC does not always accurately reflect the predominant business of the merchant. In some cases, the predominant business of the merchant may have changed over time and the MCC assigned to the merchant may have not been updated. In some cases, the acquirer may have misinterpreted the guidelines provided by the payment processing network for MCC assignment. In other cases, the acquirer may have misinterpreted the predominant business of the merchant or the merchant may have been misleading when providing a merchant description to the acquirer. For example, a high-risk merchant may wish to be categorized under a lower risk MCC in order to receive a lower interchange fee and may provide misleading or fraudulent information to the acquirer about the predominant business being performed by the merchant. The acquirer may not have the resources to perform the time-consuming task of investigating and verifying the predominant business of every single merchant to ensure that an appropriate MCC has been assigned.

In some examples of the present disclosure, a computing system for identifying an MCC-misclassified merchant may both identify merchants with incorrect assignments and provide one or more suggested MCCs that should alternatively be assigned to the merchant. Embodiments of the system and methods described herein include an algorithm for identifying and evaluating a probability that a particular merchant's MCC assignment is invalid. The exemplary system may additionally suggest a correct MCC. In other words, the system may use issuing-side data to draw conclusions about acquiring-side entities.

In a sense, embodiments of the systems execute algorithms that operate in a manner that are analogous to a familiar detective plot. In the analogy, a police detective is tasked with finding and gathering evidence on a local crime organization. An informant may tip off the detective that a criminal is using a local bakery to hold a meeting. The detective may stakeout the bakery to observe its customers. Experience in detection (e.g., street smarts) may indicate that the customers do not present themselves as typical bakery customers. The evidence may be used to get a warrant to raid the alleged bakery and arrest the criminals. In analogous terms of an embodiment of the system, a compliance team may fill the role of the detective, and tips may be received from various issuing side sources and internal processes. The detection experience, or stakeout, may be provided by a suite of cardholder propensity models. The processes and system implementing these analogous functions are described herein.

Continuing with the above analogy, indicators (e.g., tips) may be transmitted from a number of sources to a model. The model may output a MERCHANT_MARKET_HIERARCHY_ID (MMHID) corresponding to one of a plurality of merchants described by a data warehouse. A first type of indicator input may include an issuer referral of cardholder complaints. Another illustrative type of indicator may be generated by a follow-the-crowd type algorithm that tracks customers of noncompliant merchants that have been shut down for violations. Another type of indicator may include keyword search natural language processing (NLP) models that sweep a single merchant or large merchant sets for merchant names that exhibit sematic differences for what is typical for a given MCC. Machine learning models may provide another tip by comparing merchant based spend profiles to a profile typical to a given MCC. For instance, if the spending pattern of customers visiting a given merchant differs greatly from what might be expected based on its MCC, then the system may output the MMHID of that merchant as a tip.

A cardholder “propensity-to-spend-in” a particular MCC model, or propensity model, may receive inputs comprising features based on primary account number (PAN)-level spend summaries. The spend summaries may mathematically characterize a PAN's spend history and the output may include a score indicating how likely that PAN is to transact in a given MCC, usually during some time frame. In one example, a model may be available for each MCC. A PAN A customer (also referred to herein as a payor, user, or cardholder) initiates a purchase transaction (“payment transaction”) by providing payment credentials (e.g., a credit or debit card number, a bank account number, user log-in information corresponding to saved payment credentials, digital wallet information, etc.) to a merchant for the exchange of goods and/or services.

A PAN, or card number or account identifier, is the card identifier found on payment cards, such as credit cards and debit cards, as well as stored-value cards, gift cards and other similar cards or payment accounts. In some situations, the card number is referred to as a bank card number. The card number is primarily a card identifier and may not directly identify the bank account number/s to which the card is/are linked by the issuing entity. In other words, the card number or card identifier may be a token that is securely linked to an actual card identifier for data security reasons. The card number prefix identifies the issuer of the card, and the digits that follow are used by the issuing entity to identify the cardholder as a customer and which is then associated by the issuing entity with the customer's designated bank accounts. In the case of stored-value type cards, the association with a particular customer is only made if the prepaid card is reloadable. Card numbers are allocated in accordance with ISO/IEC 7812. The card number is typically embossed on the front of a payment card, and is encoded on the magnetic stripe and chip, but may also be imprinted on the back of the card

An algorithm of an example embodiment may apply propensity models in several manners to determine whether an MCC is correct for an MMHID. In one example, a merchant's customer PAN set may be scored in a propensity model that corresponds to the MCC of the merchant. If the MCC assignment is correct, an embodiment of the model may return a relatively large score. In such a configuration, people who have a propensity to spend at merchants with MCCs=x should have a high propensity to spend at the modeled merchant (also with an MCC=x).

In one such embodiment of the method, one or more MMHIDs may be selected for evaluation of the accuracy of its MCC. The selection may be random, widespread, or in response to one or more tips. For each MMHID, the method may extract a relevant customer PAN set and use it as input to the propensity model. That MCC model may have been trained using cardholder information of persons who frequent stores with that MCC. The embodiment of the method may use the propensity model to output a mean or median propensity to spend in that merchant's MCC.

More particularly, a sample of merchants having an MCC equal to x may be selected. For instance, one or more merchants may be selected using tips/indicators, random selection, or a wide-sweeping inclusive process that selects all merchants. For each MMHID, the method may include extracting the relevant customer PAN set and using it as input to the propensity model for MCC equaling x. The method may perform a statistical examination of the distribution of the merchant's customer's mean/median propensity model scores. The system may translate the mean/median scores to probabilistic statements like “the probability this merchant would have a lower mean/median customer propensity score that is less than 0.01.” This may provide compelling evidence that suggests the MCC assigned to the merchant is likely correct.

An embodiment of the method may additionally suggest a more accurate MCC should the assigned one be found to be incorrect. In such an implementation, a relevant customer PAN set of the merchant (e.g., having the inaccurate MCC) may be retrieved. The retrieved PAN set of the merchant may be input to one or more (e.g., or all) propensity models for which MCC does not equal x. For instance, those propensity models may be chosen that have a mean or median propensity to spend in one, some, or all of the MCCs other than x. Most of the output scores should be low. One or more high scores may indicate one or more possible correct MCCs for that MMHID.

In general, one or more processors of the computer systems described herein may determine whether there is a likelihood that an existing assignment of an MCC is the correct MCC for a merchant. If not, the one or more processors may output a suggestion as to what it should be. In one example, an MMHID may have an assigned four-digit MCC corresponding to an automobile repair shop. However, the MMHID should actually be assigned an MCC associated with a travel agency. An implementation may extract a PAN set from transactions at the merchant during a specified time range. The PANs may be run through a propensity model corresponding to the MCC code affiliated with automobile repair shops. A mean or median propensity score u may be computed using the extracted PAN set. An implementation may use a mean or median distribution to compute a probability p that a randomly chosen MMHID with merchant with an MCC corresponding to the same as originally assigned to the merchant would be less than or equal to u. If p is less than a business-defined threshold, then the MCC is determined to be likely inaccurate. If not, the one or more processors may determine that the MCC is correct. Where the MCC is incorrect, the extracted PAN set may be provided to every propensity model associated with a different MCC than that which was inaccurately assigned. An output may comprise a list of mean propensities. The one or more processors may compute a corresponding complementary probability that one of the evaluated MCCs more closely matches the data derived from the PAN set towards suggesting a correct MCC assignment.

At least one technical problem solved by the systems and methods provide herein includes: (i) a large amount of manual engagement is required for a detailed review of a merchant's actual business operations as compared to the merchant information provided to the acquiring bank in order to identify an MCC-misclassified merchant, (ii) inability to automatically reassign an MCC-misclassified merchant to a more accurate MCC; (iii) inability in the past to use machine learning and AI tools to accurately identify a misclassified MCC for a merchant; and (iv) inability in the past to use machine learning and AI tools to accurately predict the correct MCC for a misclassified MCC merchant.

A technical effect or improvement provided by the systems and processes described herein includes at least one of: (i) automatically identifying merchants that are likely MCC-misclassified without requiring manual review of the merchant's data, (ii) automatically identifying merchants that are likely MCC-misclassified using consumer payment transaction data previously submitted over a payment processing network in the normal course of business, without requiring additional data gathering such as web searches of the merchant's business or electronic inquiries through the merchant's consumer-facing electronic resources, (iii) automatically identifying merchants that are likely MCC-misclassified without relying on potentially fraudulent merchant-provided descriptions of the merchant's business, (iv) recommending a new MCC for a MCC-misclassified merchant, and (v) automatically reassigning a MCC-misclassified merchant to a new MCC.

As used herein, a processor may include any programmable system including systems using micro-controllers, reduced instruction set circuits (RISC), application specific integrated circuits (ASICs), logic circuits, and any other circuits or processor capable of executing the functions described herein.

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only, and thus are not limiting as to the types of memory usable for saving of a computer.

In one embodiment, a computer program is provided, and the program is embodied on a computer readable medium. In an example embodiment, the data optimization system is executed on a single computer system, without requiring a connection to a server computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the disclosure by way of example and not by way of limitation. It is contemplated that the disclosure has general application to processing financial transaction data by a third party in industrial, commercial, and residential applications.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

Unless otherwise indicated, the terms “first,” “second,” etc. are used herein merely as labels, and are not intended to impose ordinal, positional, or hierarchical requirements on the items to which these terms refer. Moreover, reference to, for example, a “second” item does not require or preclude the existence of, for example, a “first” or lower-numbered item or a “third” or higher-numbered item.

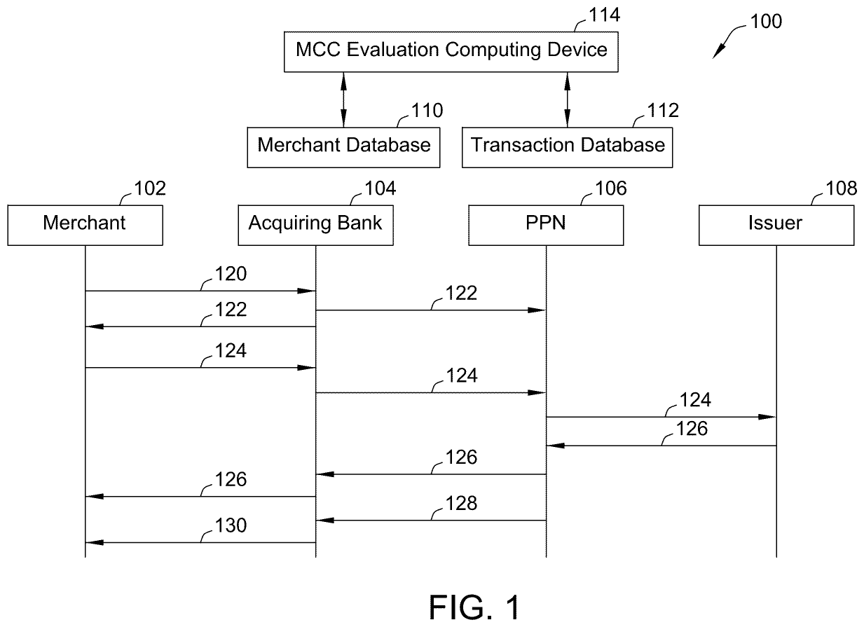

FIG. 1 is an example signal flow diagram of a payment processing system 100 including a merchant 102, an acquiring bank 104, and an issuer bank or issuer 108 in communication with each other via a payment processing network (PPN) 106. The payment processing network 106 is further in communication with a merchant database 110 and a transaction database 112. In some embodiments, payment processing network 106 is a payment card interchange network using proprietary communications protocols, such as the payment network operated by Mastercard International Incorporated. Such a network is comprised, in part, of a set of proprietary communication standard and protocols for the exchange of financial transaction data and the settlement of funds between financial institutions that are registered with the payment network.

In the example embodiment, payment processing network 106 may be configured to process authorization messages, such as ISO 8583 compliant messages and ISO 20022 compliant messages. As used herein, “ISO” refers to a series of standards approved by the International Organization for Standardization (ISO is a registered trademark of the International Organization for Standardization of Geneva, Switzerland). ISO 8583 compliant messages are defined by the ISO 8583 standard which governs financial transaction card originated messages and further defines acceptable message types, data elements, and code values associated with such financial transaction card originated messages. ISO 8583 compliant messages include a plurality of specified locations for data elements. ISO 20022 compliant messages are defined by the ISO 20022 standard. For example, ISO 20022 compliant messages may include acceptor to issuer card messages (ATICA).

In a typical payment system, issuer 108 issues a payment card associated with a payment card account, such as a credit card, debit card, electronic check, prepaid card, paper check, mobile phone with access to the payment card account, or any other form of payment, to a cardholder, who uses the payment card to tender payment for a purchase from a merchant 102. To accept payment with the payment card, merchant 102 must normally establish an account with acquiring bank 104 (also referred to herein as “merchant bank,” the “acquiring bank,” or the “acquirer”). In the example, merchant 102 initially registers with acquiring bank 104 to do business with payment processing network 106. More specifically, merchant 102 transmits a registration request message 120 including a description of the business associated with the merchant 102. The description of the business may include written descriptions of the goods and or service sold or provided by the merchant 102, documentation of financial reports, and or images/videos of the merchant's 102 location and or goods or services. Upon receiving registration request message 120, acquiring bank 104 determines and assigns an MCC to merchant 102 that most accurately reflects the goods and service provided by the merchant 102, as best understood by acquiring bank 104 based on the information provided by merchant 102.

In this example, acquiring bank 104 transmits a notification message 122 to merchant 102. Notification message 122 includes the MCC that acquiring bank 104 has assigned to the merchant 102 and an interchange fee set by payment processing network 106. The interchange fee is determined, at least partially, by the MCC that is assigned to the merchant 102. Typically, merchants 102 that are associated with a high-risk business or have been assigned to a high-risk MCC are associated with a higher interchange fee than merchants 102 assigned to other than a high-risk MCC. Merchants 102 may wish to pay a lower or decreased interchange few. In some cases, merchant 102 may provide an inaccurate or false registration request message 120 that includes false or misleading documentation of the types of goods and services provided by merchant 102. Notification message 122 is also transmitted to payment processing network 106.

In the example, payment processing network 106 stores at least a portion of the information provided in registration request 120 and at least a portion of the information provided in notification message 122 in merchant database 110. Merchant database 110 includes a plurality of merchant records associated with a respective plurality of merchants 102. Each merchant 102 has a merchant account with a respective acquiring institution 104. Each merchant record includes a merchant name, a merchant identifier (merchant ID) associated with the respective merchant 102, the MCC assigned to the respective merchant 102, and merchant data associated with the merchant 102. For example, the merchant data may include the location of the merchant 102, a description of the goods and services provided by the merchant 102, or any additional data associated with the merchant 102.

When the cardholder tenders payment for a purchase using a payment card account (either in person at a POS device or online), merchant 102 transmits an authorization request message 124, via a POS device or a merchant website or app, to acquiring bank 104 requesting authorization for the amount of the purchase. The authorization request message 124 may be transmitted over the telephone or other network, but is usually transmitted through the use of a point-of-sale (POS) terminal, which reads the cardholder's account information from a magnetic stripe, a chip, a mobile device including a digital wallet application, embossed characters, or other device on the payment card that may be manually inputted into the POS terminal, and communicates electronically with the transaction processing computers of acquiring bank 104. In some cases, acquiring bank 104 may authorize a third party to perform transaction processing on its behalf. In this case, the point-of-sale terminal will be configured to communicate with the third party. Such a third party is usually called a “merchant processor,” an “acquiring processor,” or a “third party processor,” and it should be understood that communications described herein as involving acquiring bank 104 encompass communications involving the merchant processor acting for acquiring bank 104.

Authorization request message 124 is forwarded from the computers of acquiring bank 104 via servers of the payment processing network 106 to computers of issuer 108. Issuer 108 determines whether the payment transaction should be authorized. This may include a number of factors such as whether the cardholder's account is in good standing and whether the purchase is covered by cardholder's available credit line (in the case of a credit card authorization) or existing account funds (in the case of a debit card authorization). The issuer 108 transmits an authorization response message 126 via servers of the payment processing network to merchant 102 indicating whether the payment transaction is authorized or declined. If authorized, the authorization response message 126 includes an authorization code, and if declined, the authorization response message 126 includes a reason code indicating a reason for the decline (e.g., insufficient funds). The authorization request messages 124 and the authorization response messages 126 are typically formatted using a standardized format such as ISO 8583 or ISS 20022 compliant messages. As used herein, “ISO” refers to a series of standards approved by the International Organization for Standardization (ISO is a registered trademark of the International Organization for Standardization of Geneva, Switzerland). The ISO 8583 and 20022 standards define acceptable message types, data element locations, and data element values. In addition, the ISO standard reserves several data element locations for private use.

When a request for authorization is accepted, the available credit line of the cardholder's payment card account is decreased. In some cases, a charge for a payment transaction may not be posted, e.g., “captured” immediately to the cardholder's payment card account, whereas in other cases, especially with respect to at least some debit card transactions, a charge may be posted or captured at the time of the transaction. In some cases, when merchant 102 ships or delivers the goods or services, merchant 102 captures the transaction by, for example, appropriate data entry procedures on the POS terminal. This may include bundling of approved transactions daily for standard retail purchases. If the cardholder cancels a transaction before it is captured, a “void” is generated. If the cardholder returns goods after the transaction has been captured, a “credit” is generated.

After a purchase has been made, a clearing process occurs to transfer additional transaction data related to the purchase among the parties to the transaction, such as acquiring bank 104, payment network 106, and issuer 108. After a transaction is authorized and cleared, the transaction is settled among merchant 102, acquiring bank 104, and issuer bank 30. Settlement refers to the transfer of financial data or funds among merchant's 102 accounts, acquiring bank 104 and issuer bank 108 related to the transaction. Usually, transactions are captured and accumulated into a “batch,” which is settled as a group. More specifically, a transaction is typically settled between issuer bank 108 and payment network 106, and then between payment network 106 and acquiring bank 104, and then between acquiring bank 104 and merchant 102. In some examples, during settlement a plurality of settlement messages may be exchanged (not shown)

Payment network 106 stores information extracted from one or more of authorization request messages 124, authorization response messages 126, clearing-related messages (not shown), and settlement-related messages (not shown) in transaction database 112. Transaction database 112 includes a plurality of transaction records each representative of a transaction occurring with one of a respective plurality of merchants 102. Each transaction record includes a transaction identifier (transaction ID) uniquely associated with the respective transaction, the merchant ID associated with the respective merchant 102 at which the transaction occurs, the MCC assigned to the respective merchant 102, the transaction amount, and any other suitable transaction data. For example, additional transaction data may include the date and time of the transaction or additional data associated with the transaction.

In the example, payment processing network 106 also transmits a periodic invoice message 128 to acquiring bank 104. Periodic invoice message 128 includes a summary of transactions that occurred during the relevant time period and a summary of interchange fees charged to acquiring bank 104, based at least in part on the MCC assigned to each merchant 102 and the number of transactions. Further in the example, acquiring bank 104 sends a periodic merchant invoice message 130 to each merchant 102. Merchant invoice message 130 includes an invoice for interchange fees charged in turn by acquiring bank 104 to the respective merchant 102, based on the MCC assigned to the merchant 102 and the number of transactions occurring with the merchant 102. Again, the interchange fee is determined, at least partially, by the MCC that is assigned to the merchant 102. Merchants 102 that are associated with a high-risk business or have been assigned to a high-risk MCC are associated with a higher interchange fee than merchant 102 assigned to other than a high-risk MCC. Merchants 102 may wish to pay a lower or decreased interchange fee and in some cases, merchant 102 may provide an inaccurate or false registration request message 102 that includes false or misleading documentation of the types of goods and service of merchant 102.

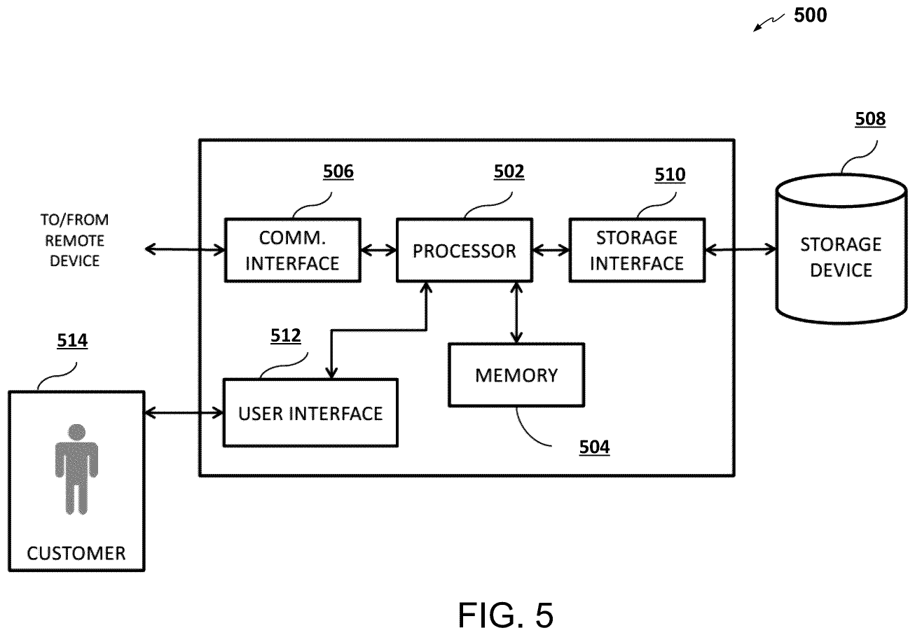

In the example embodiment, payment system 100 further includes MCC evaluation (MCCE) computing device 114. MCCE computing device 114 is in communication with merchant database 110 and transaction database 112, either via payment processing network 106 or through a separate communication channel (e.g., secure Internet connection). In some examples, MCCE computing device 114 is implemented as part of the servers of payment processing network 106. Alternatively, MCCE computing device 114 is implemented independently from the servers of payment processing network 106, and payment processing network 106 provides suitable access to data stored by payment processing network 106 in merchant database 110 and transaction database 112. As discussed in more detail below, MCCE computing device 114 includes at least one processor 502 (shown in FIG. 5) programmed to execute at least one algorithm to identify MCC-misclassified merchants 102. In certain examples, the at least one processor 502 is further programmed to recommend a reassignment of the MCC, or to automatically reassign the MCC of the misclassified merchants.

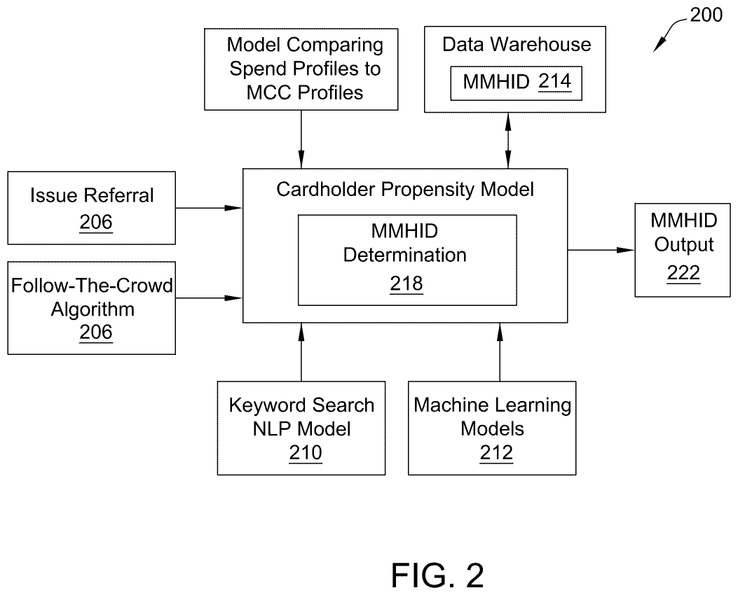

FIG. 2 is a block diagram of an example embodiment of a system 200 that includes a cardholder propensity-to-spend-in an MCC code, or propensity model 202, configured to receive inputs comprising indicators 204, 206, 208, 210, 212. The model 202 may use the indicators 204, 206, 208, 210, 212 to determine an MMHID that has potentially been assigned an incorrect MCC.

While other types of modeling algorithms are contemplated, a propensity model may have particular application as a statistical approach to predict a likelihood of a particular MMHID using various input indicators 204, 206, 208, 210, 212. More particularly, the cardholder propensity model 202 may receive inputs comprising features based on PAN-level spend summaries. The spend summaries may mathematically characterize a PAN's spend history and the output may include the MMHID output (e.g., comprising a score) indicating how likely that PAN is to transact in a given MCC during a specified time frame. The system 200 may provide a propensity model for each MCC. A PAN may initiate a payment transaction by providing payment credentials to a merchant for the exchange of goods and services. The cardholder propensity model 202 may output an MMHID 222 corresponding to one of a plurality of merchants (and merchant IDs 214) described by a data warehouse 216. As such, the cardholder propensity model 202 may include an MMHID determination module, or algorithm, the functionality of which is described herein.

As described herein, indicators 204, 206, 208, 210, 212 may be transmitted from a number of sources to the cardholder propensity model 202. A first type of indicator 206 may include an issuer referral of cardholder complaints. Another illustrative type of indicator 208 may be generated by a follow-the-crowd type algorithm that tracks customers of noncompliant merchants that have been shut down for violations. Another type of indicator 210 may comprise keyword search natural language processing (NLP) models that sweep a single merchant or large merchant sets for merchant names that exhibit sematic differences for what is typical for a given MCC. Machine learning models may provide another indicator 212 by comparing merchant based spend profiles to a profile typical to a given MCC. For instance, if the spending pattern of costumers visiting a given merchant differs greatly from what might be expected based on its MCC, then then the system 200 may output the MMHID of that merchant as the indicator 212.

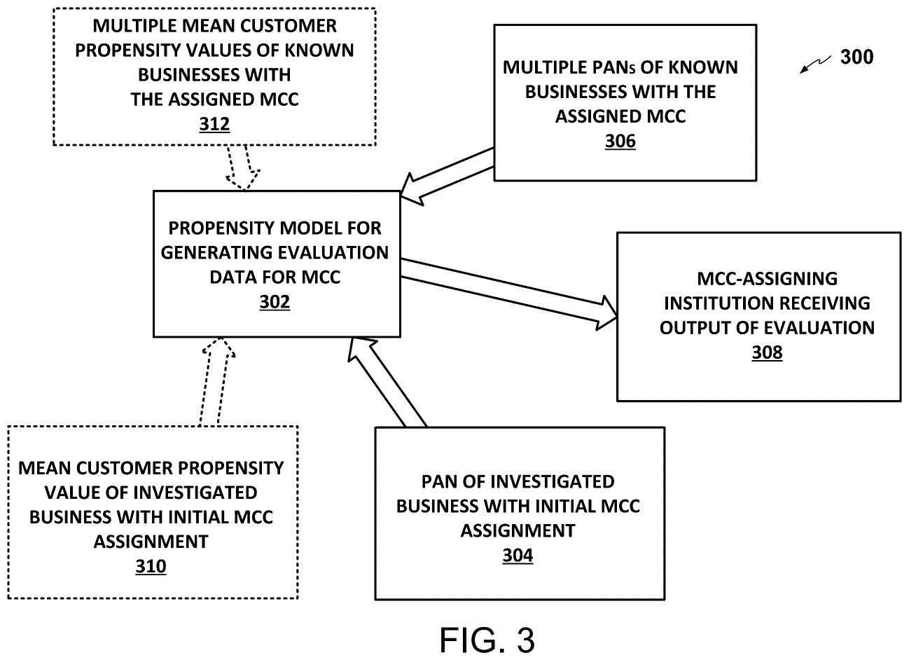

FIG. 3 is a block diagram of an example embodiment of a system 300 that includes a propensity model 302 used to determine whether an originally assigned MCC is correct for an identified MMHID of a merchant. The system 300 may comprise an implementation where multiple propensity models are available for corresponding MCCs. Put another way, there may be a propensity model 302 for each MCC, wherein each propensity model is configured to output an indication as to whether a particular PAN is likely to make a purchase from a merchant included within the given MCC. In the example of FIG. 3, a merchant's customer PAN set may be scored in the propensity model 302 that corresponds to the MCC of that merchant. If the MCC assignment is correct, an embodiment of the model 302 may return a relatively large or high score. In such a configuration, customers who have a propensity to spend at merchants at a store associated with a particular MCC should have a high propensity to spend at the modeled merchant (sharing the same MCC).

As shown in FIG. 3, a PAN 304 used at a merchant may be selected for evaluation of the accuracy of its MCC. The selection may be random, widespread, or in response to one or more indicators, such are discussed in FIG. 2. The relevant customer PAN 304 may be used as an input it to the propensity model 302.

The propensity model 302 may have been trained using cardholder information of multiple PANs 306 of persons who frequent stores with that MCC. For instance, a sampling of merchants having an MCC matching the one initially assigned to the merchant being investigated may be selected. The PANs of the sampling of merchants may be selected using indicators, random selection, or a wide-sweeping inclusive process that selects all merchants.

For the selected MMHID, the system 300 may extract the relevant customer PAN 304 and use it as input to the propensity model 302 for the MCC that was initially assigned to the selected customer. The propensity model 302 may perform a statistical examination of the distribution of the merchant's customer's mean/median propensity model scores. In some cases, the propensity model 302 may translate the mean/median scores to probabilistic statements like “the probability this merchant has a low customer propensity score that is more than 50%.” Such statistical data may provide compelling evidence that suggests the MCC assigned to the merchant is likely incorrect. The propensity model 302 may output to an MCC-assigning institution 308 the mean or median score. As discussed herein, the score may be indicative of a propensity to spend in that merchant's initially assigned MCC.

In another implementation (shown in dashed lines), the propensity model 302 may have been trained using mean or median propensity scores 312 of a plurality of merchants with an MCC corresponding to the same as originally assigned to the merchant. The merchants may be selected using indicators, random selection, or a wide-sweeping inclusive process that selects all merchants. In the example, a mean or median propensity score 310 of the merchant (e.g., generated using the extracted PAN set) may be input into the propensity model 302. Although this embodiment uses mean or median propensity scores 312 to train the model 302, those scores are trained using the account identifiers. Thus, the model 302 can still be said to be trained with multiple account identifiers used to initiate multiple purchase transactions with multiple merchants each having been properly assigned to a first MCC. The propensity model 302 may compare the input score 310 to the trained scores 312 of the propensity model 302 to determine if the MCC assigned to the merchant is likely incorrect.

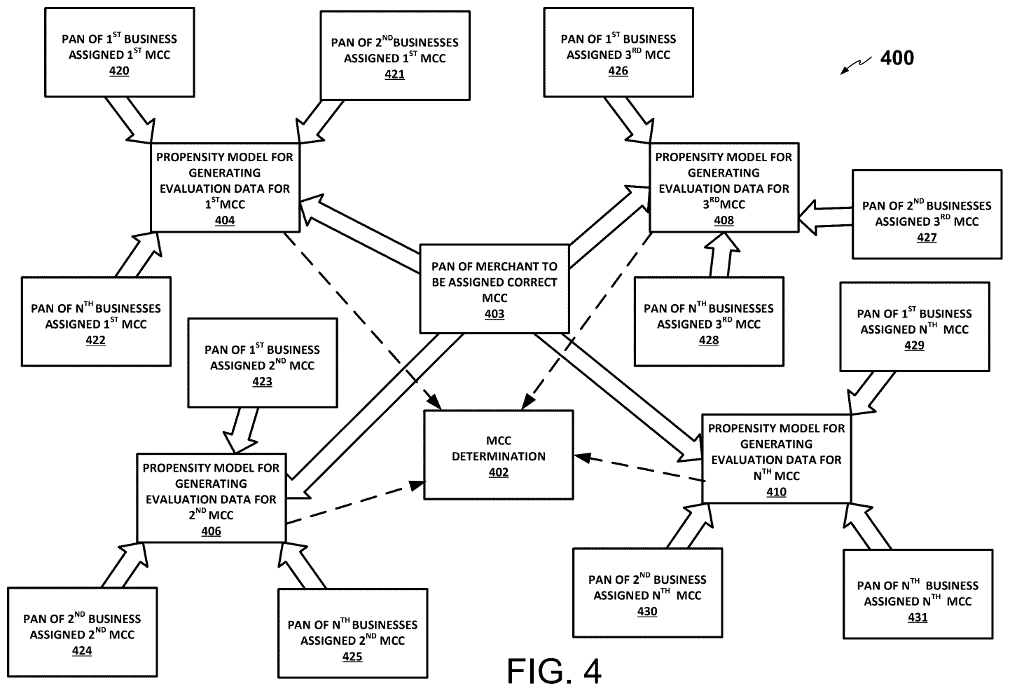

FIG. 4 is a block diagram of an example embodiment of a system 400 that includes an MCC determination module 402 configured to recommend an accurate MCC (in a case where the initially assigned MCC is found to be incorrect) by evaluating outputs from a plurality of propensity models 404, 406, 408, 410 that model PAN data 403 associated with misclassified merchant.

In the implementation shown in FIG. 4, the relevant customer PAN data 403 of the merchant (e.g., having the inaccurate MCC) may be retrieved. The retrieved PAN data 403 of the merchant may be input to one or more (e.g., or all) of the propensity models 404, 406, 408, 410 other than one corresponding to the misclassified MCC. For instance, those propensity models 404, 406, 408, 410 may be chosen that have a mean or median propensity to spend in one, some, or all of the MCCs other than that expected for the misclassified MCC. Most of the output scores should be low. One or more high scores may indicate one or more possible correct MCCs for that MMHID, as determined by the MCC determination module 402. As with all of the models described herein, the models may be continuously updated and retrained with new PAN set data and confirmed MCC assignments.

As described herein, each of the propensity models 404, 406, 408, 410 may be trained using the PANs of multiple businesses known to be correctly assigned the MCC corresponding to each, respective propensity model 404, 406, 408, 410. More particularly, PANs 420-422 may be used to train the propensity model 404, and PANs 423-425 may be used to train the propensity model 406. PANs 426-428 may be used to train the propensity model 408, and PANs 429-431 may be used to train the propensity model 410.

FIG. 5 illustrates an example configuration of a computing device 500, such as the MCCE computing device 114 shown in FIG. 1. Computing device 500 includes at least one processor 502 for executing instructions. Instructions may be stored to a memory 504. The at least one processor 502 may include one or more processing units (e.g., in a multi-core configuration) for executing instructions. The instructions may be executed within a variety of different operating systems on data optimizing computing device, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 502 is operatively coupled to a communication interface 506 such that computing device 500 is capable of communication with remote devices. Processor 502 may also be operatively coupled to at least one storage device 508. For example, the at least one storage device 508 may be used to implement merchant database 110 and transaction database 112 of FIG. 1. Storage device 508 is any computer-operated hardware suitable for storing and/or retrieving data. In some embodiments, storage device 508 is integrated in computing device 500. For example, computing device 500 may include one or more hard disk drives as storage device 508. In other embodiments, storage device 508 is external to computing device 500. For example, storage device 508 may include multiple storage units such as hard disks or solid state disks in a redundant array of inexpensive disks (RAID) configuration. Storage device 508 may include a storage area network (SAN) and/or a network attached storage (NAS) system.

In some embodiments, processor 502 is operatively coupled to storage device 508 via a storage interface 510. Storage interface is any component capable of providing processor 502 with access to storage device 508. Storage interface 510 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 502 with access to storage device 508.

Memory 504 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program.

Computing device 500 includes at least one user interface 512 for receiving commands and input from and/or presenting information to a user 514. User interface 512 may, for example, be any component capable of converting and conveying electronic information to and/or from user 514. In some embodiments, user interface 512 includes an output adapter (not shown), such as a video adapter or an audio adapter, which is operatively coupled to processor 502 and operatively coupleable to an output device (also not shown), such as a display device (e.g., a cathode ray tube (CRT), liquid crystal display (LCD), light emitting diode (LED) display, or “electronic ink” display) or an audio output device (e.g., a speaker or headphones). In some embodiments, user interface 512 is configured to include and present a graphical user interface (not shown), such as a web browser or a client application, to user 514. User 514 may display or report via user interface 512, e.g., results generated by one or more of the methods described above. Additionally or alternatively, computing device 500 includes an input device (also not shown) for receiving input from user 514. User 514 may use input device, without limitation, to initiate or execute one or more methods or processes described above. Input device may include, for example, a keyboard, a pointing device, a mouse, a stylus, a touch sensitive panel (e.g., a touch pad or a touch screen), a gyroscope, an accelerometer, a position detector, a biometric input device, or an audio input device. A single component such as a touch screen may function as both an output device and input device. Additionally or alternatively, computing device 500 is configured to receive commands to execute one or more of the methods described above from, and/or to transmit results of the methods for display to, a remote device via communication interface 506.

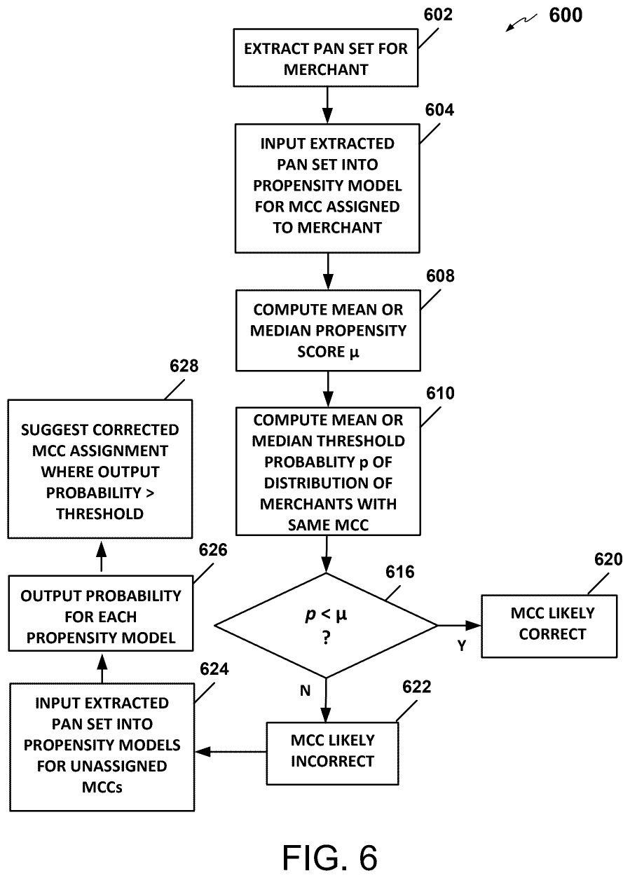

FIG. 6 is a flow diagram of an example embodiment of a method 600 of determining a likelihood that an MCC is correctly assigned, and if not, to output a suggestion as to what the MCC should be. In so doing, the method 600 may combine PAN inputs comprising a set of one or more MMHIDs coming from the various indicators described herein and as shown specifically in FIG. 2. The method 600 may be performed by any system described in the preceding figures.

In general, a processor, such as the one or more processors 502 of FIG. 5 may determine at 602-616 whether there is a likelihood that an existing assignment of an MCC is the correct MC for a merchant. If not, the one or more processors may output a suggestion as to what it should me at 610-620.

In one example, an MMHID may have an assigned four digit MCC corresponding to a bakery. However, the MMHID should actually be assigned an MCC associated with a pawn shop. An implementation may at 602 extract a PAN set from transactions at the merchant during a specified time range. The method 600 may at 604 input the PANs into a propensity model corresponding to the MCC code affiliated with bakeries. While examples described herein may refer to particular MCC codes, other implementations may use groupings of MCC codes. For instance, multiple specific MCC codes may be grouped together with other (e.g., likely related) MCC codes into a more general MCC grouping for expediency, simplification, and processing advantages. The MCC grouping nomenclature may function in the same manner as described for particular, non-generalized MCC codes.

The method 600 may compute at 608 a mean or median propensity score u using the extracted PAN set. An implementation may use a mean or median distribution at 610 to compute a probability p that a randomly chosen MMHID with merchant with an MCC corresponding to the same as originally assigned to the merchant (e.g., bakery) would be less than or equal to u. If p is less than a business-defined threshold at 616, then the MCC is determined at 620 to be likely inaccurate. If not, the method 600 may determine at 622 that the MCC is correct.

Where the MCC is incorrect at 622, the method 600 may include at 624 inputting the extracted PAN set to every propensity model having a different MCC than that which was inaccurately assigned. The output at 626 may comprise a list of mean propensities. The method 600 may compute a corresponding complementary probability for one of the evaluated MCCs that more closely matches the data derived from the PAN set towards suggesting a correct MCC assignment at 628.

The system and method described herein may include certain opt-in requirements in order for cardholders, merchants, acquirers, and/or issuers to participate within the system. For example, a cardholder using the cardholder computing device to make purchases in combination with their assigned PAN may enroll as a participating cardholder in the system for allowing their PAN to be used as part of the model training and/or as input in the model to determine whether a merchant has been properly assigned an MCC. In addition, as part of registering with the system, an issuer, a merchant and/or an acquirer may be given the option to opt-in to the system for using certain AI tools and/or models to determine whether the merchant was properly assigned an MCC. Enrollment within the system may include acceptance of certain service terms, preferred contact information (e.g., email, SMS text notification, push notification, notification via a digital wallet service, etc.) and preferences for service notifications and the like, or other desired information relating to the cardholder to provide the MCC services. In contemplated embodiments, the enrollment includes opt-in informed consent of users to data usage by the system consistent with consumer protection laws and privacy regulations. In some embodiments, the enrollment data and/or other collected data may be anonymized and/or aggregated prior to receipt such that no personally identifiable information (PII) is received. In other embodiments, the system may be configured to receive enrollment data and/or other collected data that is not yet anonymized and/or aggregated, and thus may be configured to anonymize and aggregate the data. In such embodiments, any PII received by the system is received and processed in an encrypted format, or is received with the consent of the individual with which the PII is associated. In situations in which the systems discussed herein collect personal information about individuals including cardholders or merchants, or may make use of such personal information, the individuals may be provided with an opportunity to control whether such information is collected or to control whether and/or how such information is used. In addition, certain data may be processed in one or more ways before it is stored or used, so that personally identifiable information is removed.

The following is a brief description of the functionality of the example embodiments described above. In one example embodiment, a computer implemented method using a machine learning tool for identifying and correcting a misclassified merchant category code (MCC) included within an authorization request message is provided. The computer implemented method is implemented using a computer device including at least one processor. The method includes: (i) storing a first propensity model that is trained with multiple account identifiers used to initiate multiple purchase transactions with multiple merchants each having been properly assigned to a first MCC; (ii) inputting, into the first propensity model, an account identifier used to initiate a purchase transaction with a candidate merchant assigned to the first MCC, the candidate merchant possibly being mis-assigned to a wrong MCC; (iii) outputting from the first propensity model a first score based on the inputted account identifier; (iv) comparing the outputted score to a threshold value; and (v) based on the comparison to the threshold value, determining that the candidate merchant was mis-assigned to the first MCC.

In another example embodiment, the computer implemented method described above wherein inputting the account identifier further includes inputting a primary account number (PAN) set.

In another example embodiment, the computer implemented method described above wherein inputting the account identifier further includes determining a mean or median value using the PAN set.

In another example embodiment, the computer implemented method described above further comprising suggesting a correct MCC for the candidate merchant.

In another example embodiment, the computer implemented method described above further comprising training the first propensity model with a plurality of primary account number (PAN) sets.

In another example embodiment, the computer implemented method described above further comprising using the first propensity model to calculate the threshold value.

In another example embodiment, the computer implemented method described above further comprising selecting the candidate merchant from among a plurality of merchants based on an issue referral of cardholder complaints.

In another example embodiment, the computer implemented method described above further comprising selecting the candidate merchant from among a plurality of merchants using a natural language processing model.

In another example embodiment, the computer implemented method described above further comprising randomly selecting the candidate merchant from among a plurality of merchants.

In another example embodiment, the computer implemented method described above further comprising selecting the candidate merchant from among a plurality of merchants using a follow-the-crowd algorithm that tracks multiple customers of a plurality of noncompliant merchants.

In another example embodiment, the computer implemented method described above further comprising selecting the candidate merchant from among a plurality of merchants using a machine learning model to determine merchant names that exhibit sematic differences for what is expected for the first MCC.

In another example embodiment, a computer apparatus is described. The computer apparatus includes at least one processor, and at least one memory. The memory stores a first propensity model that is trained with multiple account identifiers used to initiate multiple purchase transactions with multiple merchants each having been properly assigned to a first merchant category codes (MCC); and instructions that when executed by the at least one processor, cause the at least one processor to: (i) input, into the first propensity model, an account identifier used to initiate a purchase transaction with a candidate merchant assigned to the first MCC, the candidate merchant possibly being mis-assigned to a wrong MCC; (ii) output from the first propensity model a first score based on the inputted account identifier; (iii) compare the outputted score to a threshold value; and based on the comparison to the threshold value, determine that the candidate merchant was mis-assigned to the first MCC.

In another example embodiment, the apparatus described above wherein the account identifier includes a primary account number (PAN) set.

In another example embodiment, the apparatus described above wherein the at least one processor is further configured to determine the account identifier by determining a mean or median value using the PAN set.

In another example embodiment, the apparatus described above wherein the at least one processor is further configured to suggest a correct MCC for the candidate merchant.

In another example embodiment, the apparatus described above wherein the at least one processor is further configured to train the first propensity model with a plurality of primary account number (PAN) sets.

In another example embodiment, the apparatus described above wherein the at least one processor is further configured to select the candidate merchant from among a plurality of merchants based on an issue referral of cardholder complaints.

In another example embodiment, the apparatus described above wherein the at least one processor is further configured to select the candidate merchant from among a plurality of merchants using a natural language processing model.

In another example embodiment, a non-transitory computer-readable storage medium that includes computer-executable instructions executable by at least one processor for identifying merchant category code (MCC) misclassifications is described. The at least one processor is in communication with the non-transitory computer-readable storage medium. When executed, the instructions cause the at least one processor to: (i) store a first propensity model that is trained with multiple account identifiers used to initiate multiple purchase transactions with multiple merchants each having been properly assigned to a first MCC; (ii) input, into the first propensity model, an account identifier used to initiate a purchase transaction with a candidate merchant assigned to the first MCC, the candidate merchant possibly being mis-assigned to a wrong MCC; (iii) output from the first propensity model a first score based on the inputted account identifier; (iv) compare the outputted score to a threshold value; and (v) based on the comparison to the threshold value, determine that the candidate merchant was mis-assigned to the first MCC.

In another example embodiment, the non-transitory computer-readable storage medium described above, wherein the account identifier includes a primary account number (PAN) set.

As will be appreciated based on the foregoing specification, the above-described embodiments of the disclosure may be implemented using computer programming or engineering techniques including computer software, firmware, hardware or any combination or subset thereof, wherein the technical effect or enabling individual chargeback tracking, settlement, and recording. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer-implemented method using a machine learning tool for identifying and correcting a misclassified merchant category code (MCC) included within a request message, the computer-implemented method implemented using a computer device including at least one processor, the method comprising:
storing a first propensity model that is trained with multiple account identifiers used to initiate multiple purchase transactions with multiple merchants each having been properly assigned to a first MCC;
inputting, into the first propensity model, an account identifier used to initiate a purchase transaction with a candidate merchant assigned to the first MCC, the candidate merchant possibly being mis-assigned to a wrong MCC;
outputting from the first propensity model a first score based on the inputted account identifier;
comparing the outputted score to a threshold value; and
based on the comparison to the threshold value, determining that the candidate merchant was mis-assigned to the first MCC.

2. The computer-implemented method of claim 1, wherein inputting the account identifier further comprises inputting a primary account number (PAN) set.

3. The computer-implemented method of claim 2, wherein inputting the account identifier further comprises determining a mean or median value using the PAN set.

4. The computer-implemented method of claim 1, further comprising suggesting a correct MCC for the candidate merchant.

5. The computer-implemented method of claim 1, further comprising training the first propensity model with a plurality of primary account number (PAN) sets.

6. The computer-implemented method of claim 1, further comprising using the first propensity model to calculate the threshold value.

7. The computer-implemented method of claim 1, further comprising selecting the candidate merchant from among a plurality of merchants based on an issue referral of cardholder complaints.

8. The computer-implemented method of claim 1, further comprising selecting the candidate merchant from among a plurality of merchants using a natural language processing model.

9. The computer-implemented method of claim 1, further comprising randomly selecting the candidate merchant from among a plurality of merchants.

10. The computer-implemented method of claim 1, further comprising selecting the candidate merchant from among a plurality of merchants using a follow-the-crowd algorithm that tracks multiple customers of a plurality of noncompliant merchants.

11. The computer-implemented method of claim 1, further comprising selecting the candidate merchant from among a plurality of merchants using a machine learning model to determine merchant names that exhibit sematic differences for what is expected for the first MCC.

12. A computer device comprising:
at least one processor; and
at least one memory in communication with the at least one processor, the at least one memory for storing:
a first propensity model that is trained with multiple account identifiers used to initiate multiple purchase transactions with multiple merchants each having been properly assigned to a first merchant category codes (MCC); and
instructions that, when executed by the at least one processor, cause the at least one processor to:
input, into the first propensity model, an account identifier used to initiate a purchase transaction with a candidate merchant assigned to the first MCC, the candidate merchant possibly being mis-assigned to a wrong MCC;
output from the first propensity model a first score based on the inputted account identifier;
compare the outputted score to a threshold value; and
based on the comparison to the threshold value, determine that the candidate merchant was mis-assigned to the first MCC.

13. The computer device of claim 12, wherein the account identifier includes a primary account number (PAN) set.

14. The computer device of claim 13, wherein the at least one processor is further configured to determine the account identifier by determining a mean or median value using the PAN set.

15. The computer device of claim 12, wherein the at least one processor is further configured to suggest a correct MCC for the candidate merchant.

16. The computer device of claim 12, wherein the at least one processor is further configured to train the first propensity model with a plurality of primary account number (PAN) sets.

17. The computer device of claim 12, wherein the at least one processor is further configured to select the candidate merchant from among a plurality of merchants based on an issue referral of cardholder complaints.

18. The computer device of claim 12, wherein the at least one processor is further configured to select the candidate merchant from among a plurality of merchants using a natural language processing model.

19. A non-transitory computer-readable storage medium that includes computer-executable instructions executable by at least one processor for identifying merchant category code (MCC) misclassifications, wherein when executed by the at least one processor, the computer-executable instructions cause the at least one processor to:
store a first propensity model that is trained with multiple account identifiers used to initiate multiple purchase transactions with multiple merchants each having been properly assigned to a first MCC;
input, into the first propensity model, an account identifier used to initiate a purchase transaction with a candidate merchant assigned to the first MCC, the candidate merchant possibly being mis-assigned to a wrong MCC;
output from the first propensity model a first score based on the inputted account identifier;
compare the outputted score to a threshold value; and
based on the comparison to the threshold value, determine that the candidate merchant was mis-assigned to the first MCC.

20. The non-transitory computer-readable storage medium of claim 19, wherein the account identifier includes a primary account number (PAN) set.
